(19) United States
(12) Patent Application Publication
(10) Pub. No.: US 2011/0023733 A1
(43) Pub. Date: Feb. 3, 2011

(54) PRESS AND METHOD FOR FEEDING WORK PIECES INTO AND OUT OF THE PRESS

(75) Inventor: Nobert Damm, Karlsdorf-Neuthard (DE)

Correspondence Address: VOLPE AND KOENIG, P.C., UNITED PLAZA, 30 SOUTH 17TH STREET, PHILADELPHIA, PA, 19103, US

(73) Assignee: ROBERT BURKLE GMBH, Freudenstadt (DE)

(21) Appl. No.: 12/844,943

(22) Filed: Jul. 28, 2010

(30) Foreign Application Priority Data
Jul. 31, 2009 (DE) 102009035633.9

(51) Int. Cl. B30B 15/30; B65G 47/74

(52) U.S. Cl. 100/215; 198/343.1

(57) ABSTRACT

A press that comprises at least one press stage with a lower and upper press plates that can be moved relative to each other for opening and closing the press stage is provided having a conveyor belt circulating around the lower press plate for feeding a work piece to be processed into and out of the press stage. The lower press plate is provided with a tensioning device for tensioning and relaxing the conveyor belt, as well as a belt-run correction device. The belt-run correction device comprises a displacement device for shifting the conveyor belt perpendicular to a running direction and this displacement device is synchronized with the tensioning device such that the conveyor belt is displaced for performing a correction movement in its relaxed state and when the conveyor belt is stopped.

### CROSS-REFERENCE TO RELATED APPLICATIONS

This application claims the benefit of German Patent Application No. DE 10 2009 035 633.9, filed Jul. 31, 2009, which is incorporated herein by reference as if fully set forth.

### BACKGROUND

The invention relates to a press as well as a method for feeding work pieces into and out of a press stage of such a press.

A press of the present type comprises, accordingly, at least one press stage with a lower and an upper press plate that can be moved relative to each other for opening and closing the press stage and with a conveyor belt circulating around the lower press plate for feeding a work piece to be pressed into and out of the press stage. The lower press plate of the press stage is provided with a tensioning device for tensioning and relaxing the conveyor belt and by use of this tensioning device, the conveyor belt for feeding the work piece in and out is tensioned. Between the feeding of the work piece in and out, and indeed before the closing of the press stage, the conveyor belt is relaxed using the tensioning device, so that the pressing process can be performed uninfluenced by a tension of the conveyor belt.

As in all conveyor belts, for a press of the present type it is also not unproblematic to stop the conveyor belt in the running path or in its track, because during operation the conveyor belt tends to run out from the running path perpendicular to its running direction, that is, to the right or left viewed horizontally in the running direction. Such a horizontal progression of the conveyor belt must be prevented or corrected from time to time, in order to avoid an otherwise inevitable disruption in the operation of the conveyor belt. Accordingly, a press of the present type is also provisioned for the belt-run correction of the conveyor belt.

For conventional conveyance devices with conveyor belts that circulate around drive and guide rollers, it is typical to construct these rollers with a barrel or double-cone shape, in order to cause a self-centering of the conveyor belt in the running path during the belt run. In addition, positive-fit guide elements, such as a V-belt-shaped attachment on the inside of the conveyor belt that runs in grooves of the drive and deflection rollers, are known with whose help a progression of the conveyor belt from its running path can be prevented.

For a press of the present type, however, conveyor belts are often used that have a relatively wide and short construction, that is, a ratio between the spacing of the two deflection axes and the width of the conveyor belt of less than ca. 2:1. For such relatively short and wide transport belts, the above-noted conventional measures for belt-run correction often do not lead to satisfactory results, which leads to frequent disruptions. Therefore, for presses of the present type, it has become typical to use an active belt-run control. This acts selectively on the tensioning device of the conveyor belt, in order to correct or to compensate through asymmetric tensioning (stronger on the left side than on the right side or vice versa) a progression of the conveyor belt or a recognized progression trend during the transport movement.

Such active belt-run control, however, is complicated. In addition, for a preferred application of a press of the present type, the lamination of essentially plate-shaped work pieces under the effect of pressure and heat in a vacuum chamber that is formed by one-part or two-part seals between the lower press plate and the upper press plate, slightly flexible fabric belts, advantageously made from aramid fibers, are used as the conveyor belts that must also be coated with PTFE due to the high-adhesion adhesive used for the lamination. An active belt control for such conveyor belts must expend relatively high adjustment forces, in order to stop the conveyor belts in the track.

This increases the mechanical loading both on the tensioning device and also on the conveyor belt itself, which ultimately leads to increased wear.

For such inflexible conveyor belts that require high adjustment forces for the active belt control, there is also the risk of a fold forming in the conveyor belt, because the transverse forces applied for the belt-run correction on the conveyor belt can exceed the local friction forces between the conveyor belt and the drive roller or deflection roller. Relatively wide conveyor belts are especially affected by this additional risk.

For another preferred use of a press of the present type, this is constructed as a multi-stage press, wherein the upper press plate of one press stage is simultaneously the lower press plate of the next higher press stage. The lower belt run of the conveyor belt circulating around the lower press plate runs accordingly underneath the upper press plate of another press stage located underneath through this stage. Now if active belt control is used, it happens that, through the asymmetric tension relationships in the conveyor belt, one side of this belt is slack while the other side is tensioned. Such slack naturally disturbs the transport of the work piece into and out of the underlying press stage and must be avoided accordingly—which is possible only to a limited extent, in turn, for relatively short and wide transport belts.

Independent of the material of the conveyor belt and independent of the use of the press, active belt control for belt-run correction is ultimately also a potential source of error in the entire process.

### SUMMARY

Starting from this prior art, the present invention is based on the objective of simplifying and improving a press and a method of the type noted above with respect to the belt-run correction.

This objective is met by a press according to the invention and also by a method according to the invention.

Preferred constructions of the press and method according to the invention are described in detail below and in the claims.

The present invention provides that a belt-run correction is realized by a correction movement comprising a displacement of the conveyor belt perpendicular to its running direction. The displacement device used for this purpose is here synchronized with the tensioning device such that a displacement of the conveyor belt is performed for carrying out a correction movement when the conveyor belt is stopped and in its relaxed state. In contrast to the prior art, the belt-run correction is thus not performed during the operation of the conveyor belt by an active belt control, but instead a position correction of the conveyor belt is performed at standstill and in the relaxed state, and indeed also only when there is a need for such correction.

Preferably, the correction movement is performed only when needed after reaching or exceeding a specified deviation of an actual position of the conveyor belt or a belt edge of this conveyor belt from an ideal desired position. This allows pragmatic belt-run correction in which engagement takes place only when the progression of the conveyor belt has exceeded or threatens to exceed a tolerable value. In this way, the frequency of the correction movements of the conveyor belt is advantageously minimized.

For further simplification of the correction engagement and for simplification of the displacement device required for this purpose, the correction movement can be performed with a fixed displacement path. Because this can correspond according to the invention with the reaching or exceeding of a specified actual-desired deviation, a very simple but effective belt-run correction is realized.

The requirement for such correction movement can be triggered in the scope of the present invention by a belt-edge detection sensor that detects the horizontal actual position of a belt edge of the conveyor belt. This can be, for example, an imaging sensor that can detect a specified deviation of the actual position of the belt edge of the conveyor belt from a desired position and optionally generates a correction signal, but it can also involve a plurality of sensors, in particular, two belt-edge detection sensors that enclose between themselves a desired region for the horizontal position of the belt edge of the conveyor belt and generate a correction signal when the belt edge passes the measurement region of one of the two belt-edge detection sensors. Furthermore, it is possible to place on each belt edge a belt-edge detection sensor, in order to define such a desired region.

Another possibility for detecting the need of a correction movement is given in the scope of the present invention in that a belt-edge detection sensor could be provided that monitors a desired threshold for the position of a belt edge of the conveyor belt, while the tensioning device loads the conveyor belt with an asymmetrically acting tension, so that this is displaced horizontally toward the desired threshold value during operation. When this value is reached, a correction movement that resets the conveyor belt horizontally is then triggered at the next relaxed stoppage of the conveyor belt. This refinement of the invention allows the use of very simple belt-edge detection sensors and a displacement device could be used that displaces the conveyor belt in always the same direction and advantageously by the same amount.

The displacement device of the press according to the invention advantageously comprises at least one gripper with two gripper halves that can open and close and clamp the conveyor belt between themselves in the closed state. These gripper halves can be constructed, in particular, as gripper bars or as clamp chucks. According to requirements, such a gripper arranged on the side next to the conveyor belt could pull or push, or else, if necessary, both, the conveyor belt. If the conveyor belt does not have high inherent stability, it is useful to let the gripper only pull, wherein then grippers are arranged optionally on both sides, in order to be able to pull the conveyor belt in both transverse directions. In addition, it is also possible that the gripper halves extend across the entire width of the conveyor belt, so that they can displace this belt horizontally, without this being divided into a pulling or pushing movement.

The lower gripper half of the gripper can be constructed as a conveyor belt guide that advantageously assumes a fixed vertical position, while accordingly the upper gripper half can move vertically, in particular, it is held so that it can pivot or rotate eccentrically. The gripper thus also takes over a guiding or supporting function for the conveyor belt, while advantageously it has a simple structural construction.

The two gripper halves of the gripper can be held on at least one common base part of the gripper that can move perpendicular to the running direction of the conveyor belt for realizing a correction movement, wherein this base part is mounted, in turn, advantageously laterally next to the conveyor belt on the lower press plate or the tensioning device. This base part is advantageously provided with electrical or pneumatic drives for the closing movement of the gripper and the correction movement.

A construction of the gripper or the displacement device as a chuck that is provided with a common drive for the closing movement and the correction movement is particularly unsusceptible to disruptions, wherein the progression of the closing movement and the correction movement is realized in a known way by the use of a hinge arrangement and restoring springs.

An arrangement of the displacement device according to the invention on the lower belt run of the conveyor belt is especially preferred, so that the correction movement is performed on the lower belt run; this is because, for a press of the present type, one tries to not let the conveyor belt project too far from the press stage or an optional vacuum chamber, so that, on the upper belt run of the conveyor belt, little free installation space remains for accommodating the displacement device.

One especially preferred construction of the present invention involves a multi-stage press, i.e., several press stages are arranged one above the other each with a conveyor belt circulating around the corresponding lower plate; as mentioned above, for a multi-stage press, special improvements are given by the present invention in that active belt-run control by asymmetric tensioning can be eliminated, so that the disadvantageous one-sided slack of the lower belt run of the conveyor belt during the feeding in and out of the work pieces is eliminated.

If a gripper with two gripper halves is used in a multi-stage press as the displacement device, advantageously the lower gripper halves of the gripper of at least the press stages arranged above another press stage are provided with rollers. This offers advantages because the lower gripper halves come to lie on the conveyor belt of the next underlying press stage when the press is closed. The equipment with rollers then reduces the friction between the lower gripper half and this conveyor belt on one side, as well as the lower belt run of the upper conveyor belt on the other side.

In an especially preferred application, the present invention is used in a press for the lamination of essentially plate-shaped work pieces under the effect of pressure and heat. For this press, in the closed state, by surrounding one-part or multiple-part seals, the lower press plate and the upper press plate form a vacuum chamber within which a work piece or multiple work pieces can be laminated simultaneously. A membrane divides this vacuum chamber into a product space that can be evacuated and provided for holding at least one work piece and a pressure space that can be evacuated and/or pressurized. Due to a pressure difference in the vacuum chamber generated by the evacuation of the product space and/or by the pressurization of the pressure space, the membrane is pressed against the work piece, by which it applies the load necessary for lamination to the work piece. As a rule, the bottom side of the vacuum chamber is formed by a heating plate, so that the process heat needed for lamination is introduced directly into the work piece during the press process.

Such a lamination process is used preferably for the lamination of photovoltaic modules. These typically consist of a solar cell layer that is arranged together with its electrical contact elements between a glass plate and a weather-resistant film or else between two glass plates and is laminated with the glass plates or films using one or more adhesive layers and in this way encapsulated in a moisture-tight as well as weather-resistant way in a transparent layered composite. The adhesives used here are highly adhesive and place special requirements, in particular, on the conveyor belts.

In order to laminate one work piece or multiple work pieces simultaneously in such a lamination press, the work piece is fed by the conveyor belt into the product space of the vacuum chamber and then the conveyor belt is relaxed. Then the vacuum chamber is closed and normally the pressure space of the vacuum chamber is first evacuated, in order to pull the membrane upward toward the upper chamber half. Then the product space is also evacuated, typically with a certain time offset, wherein the evacuation of both spaces of the vacuum chamber is regulated so that a differential pressure always remains between the pressure chamber and the product space, wherein this differential pressure holds the membrane in the upper chamber half and prevents the membrane from being led prematurely into contact with the work piece.

When the product space of the press chamber has been evacuated up to a desired pressure that lies as a rule underneath one millibar, the pressure space is supplied with air, so that the pressure difference between the pressure space and the product space reverses and the membrane is set on the work piece. By regulating the pressure in the pressure space, a desired contact pressure of the membrane is set, in order to generate the load on the work piece necessary for the lamination. The pressure and the process heat then provide together for the softening or activation of the adhesive layer and optionally for their hardening or cross-linking. The rapid evacuation, in particular, of the product space of the vacuum chamber—as much as possible before significant heating of the work piece—allows any air inclusions (trapped air between the work piece layers) or possible gases formed during the heating to be drawn out from the work piece before hardening or cross-linking of the adhesive begins in the adhesive layer. This is because gas bubbles in the completely laminated work piece negatively affect its service life considerably or lead, in the most unfavorable case, to the immediate unusability of the work piece, that is, to the production of rejects.

Because the work piece during lamination does not contact the bottom side of the vacuum chamber or the heating plate directly, but instead contacts the transport belt, this transport belt must be comparatively thin. Normally, the thickness of this transport belt lies under 1 mm, in order to obstruct the sealing of the surrounding seals between the lower press plate and the upper press plate as little as possible; this is because the transport belt passes through the vacuum chamber even for a closed press and is thus clamped at two sides of the vacuum chamber into the surrounding seals. In the region of the work pieces, the conveyor belts are normally constructed even thinner, as much as possible only between 0.2 and 0.5 mm, in order to guarantee good heat transfer as much as possible between the heating plate and the work piece.

At the same time, for the lamination of photovoltaic modules, conveyor belts are usually coated with PTFE. Such a coating has proven very effective against unintended adhesive residue discharged from the work pieces; these can then not adhere to the conveyor belt.

This special construction of conveyor belts that are used due to the specific problems during the lamination of photovoltaic modules magnify the problems described above enormously for the belt-run correction methods used according to the prior art. The position correction of the conveyor belts according to the invention in stoppage and in the relaxed state using a displacement device, in particular, gripper bars, here provides aid and, in particular, significantly longer service life of the conveyor belts.

Furthermore, the present invention allows an effective belt-run correction for conveyor belts that pass together through, for example, multi-stage presses arranged in series one after the other, in order to carry out a short-cycle lamination process. Each conveyor belt here passes through the n-th stage of exactly two or more multi-stage presses that are arranged one after the other and interact in a clocked way. Because these n-th stages of multiple presses are loaded by one and the same conveyor belt, the structural expense is reduced considerably.

Just for lamination presses, but also for other presses, for example, also cooling presses, the great advantage is also finally produced by the present invention that the tensioning device is no longer used for active belt-run control. This allows the conveyor belt to be tensioned straight so that the required friction fit is established between the conveyor belt and its drive roller. The tensioning device can here be loaded typically with approximately only one fourth to one third of the tensioning force that is typical according to the prior art.

### BRIEF DESCRIPTION OF THE DRAWINGS

One embodiment for a multi-stage press constructed according to the invention will be described and explained below with reference to the accompanying drawings. Shown are:

FIG. 1 is a schematic side diagram of a multi-stage press, ready for loading or unloading,

FIG. 2 is a diagram like FIG. 1, but with relaxed conveyor belts for closing the press,

FIG. 3 is a diagram like FIG. 2, but with active belt-run correction,

FIG. 4 is a diagram as in the preceding figures, but for a closed press,

FIG. 5 is a schematic front view of a detail from FIG. 2, and

FIG. 6 is a schematic front view of a detail from FIG. 3.

### DETAILED DESCRIPTION OF THE PREFERRED EMBODIMENTS

In FIGS. 1 to 4, a press with a total of four press stages 1, 1′, 1″, and 1′″ is shown that can be moved vertically together and apart synchronously in a press frame 2. FIG. 1 shows the opened press, while FIG. 4 shows the closed press.

Each press stage 1 includes a lower press plate 3 and an upper press plate 4, and a conveyor belt 5 circulates around the lower press plate 3 for loading and unloading the press stage 1. A tensioning device 6 formed essentially from a pneumatic piston-cylinder unit acting on the axle of a deflection roller 7 of the conveyor belt 5 ensures that the conveyor belt 5 circulates under tension around the deflection roller 7 and a drive roller 8, in order to move a (not-shown) work piece into the press stage 1 or to move it out of the press stage 1. A displacement device 9, described in more detail below, for belt-run correction is also arranged on the lower belt run of the conveyor belt 5.

The present embodiment of a multi-stage press constructed according to the invention involves a lamination press for laminating photovoltaic modules. Accordingly, each upper press plate 4 (that is simultaneously the lower press plate 3′ of the corresponding press stage 1′ arranged above) carries, on its bottom side, a double frame 10 in which a membrane 11 is tensioned. With the upper and lower surrounding seals 12, 13 that seal against the lower press plate 3 and the upper press plate 4, respectively, the double frame 10 forms, together with the adjacent press plates 3, 4, a vacuum chamber with (not-shown) channels for the evacuation and/or pressurization processes.

FIG. 1 now shows the situation before the press is loaded with work pieces. For this purpose, the press is opened (thus, all of the press stages 1, 1′, 1″, 1′″ are opened synchronously) and the conveyor belts 5 are tensioned symmetrically by means of their tensioning devices 6 such that the friction of the conveyor belts on the drive rollers 8 is sufficient for performing a defined conveyance movement for moving the work pieces in. Due to the symmetric tensioning of the conveyor belts 5, none of the belts on the left side or right side are slack, so that the path for moving the work pieces into all of the press stages 1 is free.

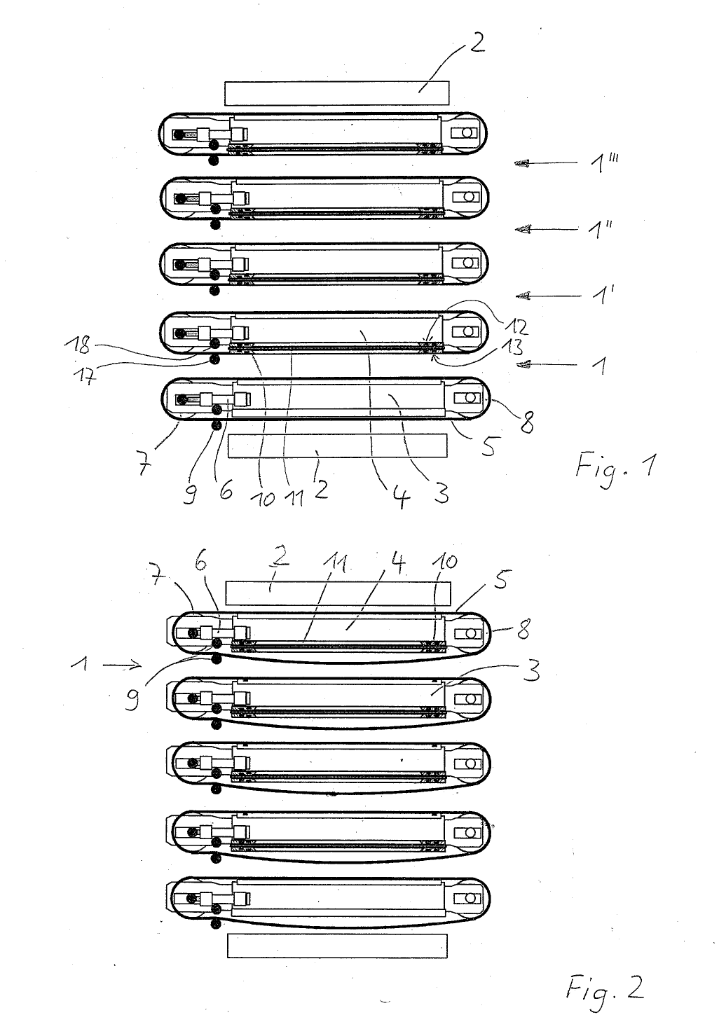

FIG. 2 shows the press in a subsequent process phase: here, after the (not shown) work pieces are moved in, the conveyor belts 5 are relaxed in that the piston-cylinder units 6 are moved together. Accordingly, the lower belt runs of the conveyor belts 5 are now slack symmetrically. By relaxing the conveyor belts 5 before closing the press, it is prevented that the belt tension of each conveyor belt 5 running twice through each vacuum chamber negatively influences the closing of the vacuum chambers and the actual lamination process.

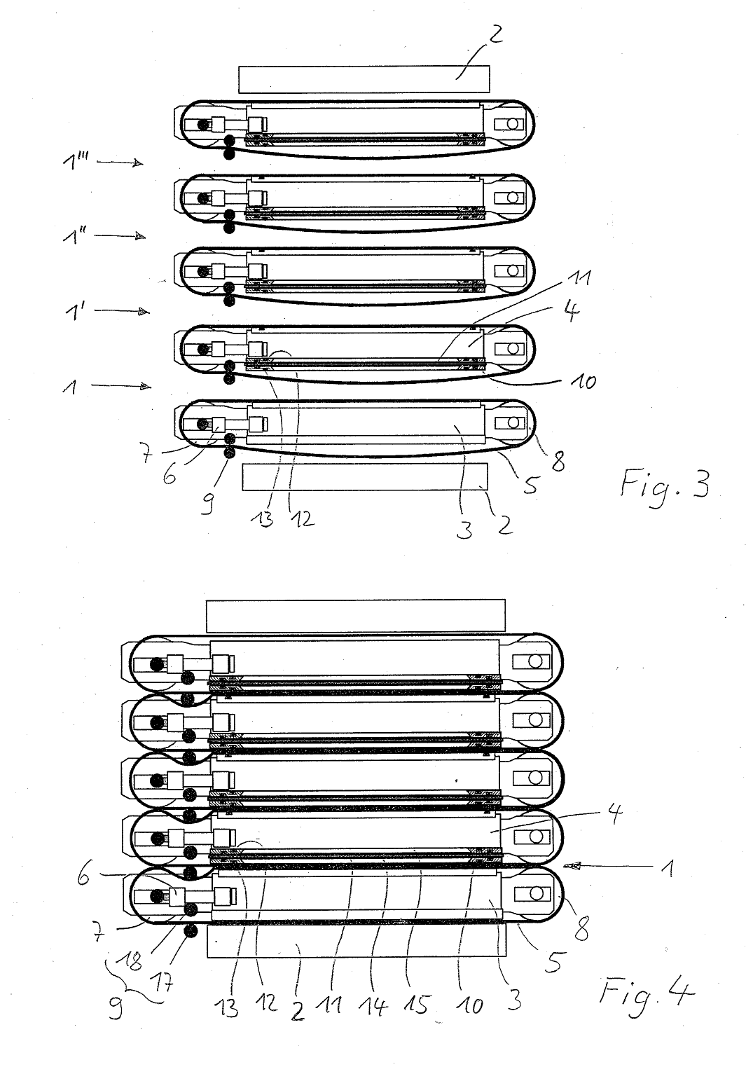

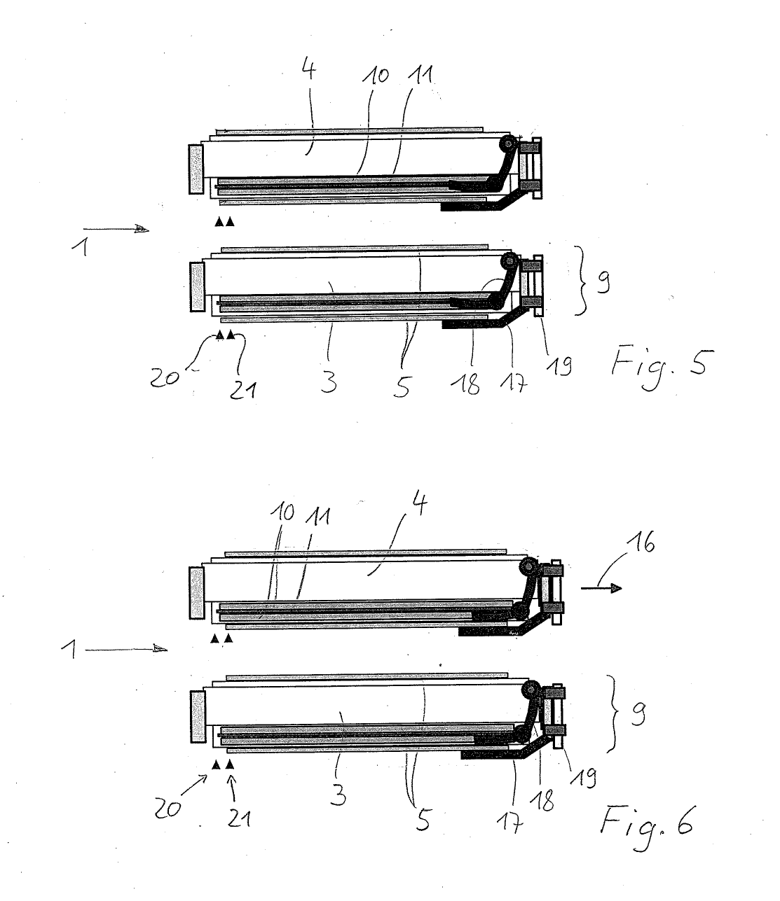

In FIG. 3 it is indicated that in the situation of the still opened press already shown in FIG. 2 with relaxed conveyor belts 5, a belt-run correction is performed. Here, the displacement devices 9 are activated, so that they engage each conveyor belt 5 in a clamping manner and are displaced horizontally (as naturally is not recognizable in this diagram), transverse to the belt-run direction. This will be described in more detail below with reference to FIGS. 5 and 6.

In FIG. 4, finally the situation at the beginning of the actual lamination process is shown. The conveyor belts 5 are further relaxed, while the press is closed. The displacement devices 9 are, in turn, inactive, as also the tensioning devices 6. The vacuum chambers formed within the double frame 10 form, between each of the lower press plates 3 and each of the upper press plates 4, a product space 14 and a pressure space 15 that are separated by the membrane 11 and the lamination process operates in a known manner. After lamination, the press is opened again and the conveyor belts 5 are tensioned, so that the situation shown in FIG. 1 is produced again. Then the laminated work pieces can be discharged and new work pieces to be laminated are fed in.

In a schematic front view, FIGS. 5 and 6 show details of the situations shown in FIGS. 2 and 3 for the multi-stage press. Accordingly, in FIG. 5 the press is opened, the conveyor belts 5 are relaxed, and the displacement devices 9 are inactive. In FIG. 6, the press is likewise opened and the conveyor belts 5 are relaxed; however, here the displacement devices 9 are active and perform a correction movement 16 of the belt run.

In each of FIGS. 5 and 6, only one press stage 1 is shown completely, wherein parts of the press stage 1′ lying above, in particular, its transport belt 5′, is necessarily also shown.

The lower press plate 3 carries, as a displacement device 9, a gripper with a lower gripper half 17 and an upper gripper half 18. These two gripper halves 17, 18 are mounted on a base part 19 that can move horizontally, transverse to the belt-run direction, wherein this base part is held on its side on the lower press plate 3 and is provided with (not shown) drives for opening and closing the two gripper halves 17, 18 and for performing the correction movement 16.

The lower gripper half 17 is constructed as a vertically-immovable guide bar arranged rigidly on the base part 19 for the conveyor belt 5, while the upper gripper half 18 is provided with two pivot axes, in order to selectively release (FIG. 5) the conveyor belt 5 or to clamp (FIG. 6) this belt between the two gripper halves 17, 18.

The displacement device 9 engages the lower belt run of the conveyor belt 5 and is in the position to pull or push this belt in both directions transverse to the belt-run direction. On the belt edge of the conveyor belt 5 opposite the displacement device 9 there are two belt-edge detection sensors 20, 21 that have a very simple and robust construction and each have only a small-surface-area-acting measurement region accordingly. These two belt-edge detection sensors 20, 21 cover a desired region for the horizontal position of the belt edge of the conveyor belt 5 between themselves and generate a correction signal, as soon as the monitored belt edge leaves this desired region. The correction stroke of the correction movement 16 transmitted from the displacement device 9 to the conveyor belt 5 corresponds approximately to half the extent of the desired region spanned by the belt-edge monitoring sensors 20, 21. This correction stroke therefore can be selected to be constant; this is because, as soon as one of the two belt-edge monitoring sensors 20, 21 outputs a correction signal, at the next belt stoppage in the relaxed state, the displacement device 9 performs the corresponding correction movement, by which the belt edge of the conveyor belt 5 is led again approximately centrally between the two monitoring sensors 20, 21.

At this point it is to be emphasized that the embodiment shown schematically in the present figures for a displacement device according to the invention could also be constructed completely differently, as discussed in the general portion of the present description.

1. Press comprising at least one press stage (1, 1′, 1″, 1′″) with a lower press plate (3) and an upper press plate (4) that can be moved relative to each other for opening and closing the press stage (1) and a conveyor belt (5) circulating around the lower press plate (3) for feeding a work piece to be processed into and out of the press stage (1), the lower press plate (3) is provided with a tensioning device (6) for tensioning and relaxing the conveyor belt (5), as well as with a belt-run correction device, the belt-run correction device comprises a displacement device (9) for displacing the conveyor belt (5) perpendicular to a running direction of the conveyor belt and the displacement device is synchronized with the tensioning device (6) such that the conveyor belt (5) is displaced for performing a correction movement (16) in a relaxed state and when the conveyor belt (5) is stopped.

2. The press according to claim 1, wherein the displacement device (9) comprises at least one gripper with two gripper halves (17, 18) that can be opened and closed, and include gripper bars or clamping chucks that clamp the conveyor belt (5) between themselves in a closed state.

3. The press according to claim 2, wherein the lower gripper half (17) is constructed as a conveyor belt guide, and the upper gripper half (18) can move vertically relative to the lower gripper half (17), and is mounted so that it can pivot or rotate eccentrically.

4. The press according to claim 3, wherein the two gripper halves (17, 18) are held on at least one common base part (19) that is movable perpendicular to a running direction of the conveyor belt (5) for performing a correction movement (16).

5. The press according to claim 4, wherein the base part (19) is provided with at least one of electrical or pneumatic drives for performing a closing movement of the gripper (17, 18) and the correction movement (16).

6. The press according to claim 2, wherein the gripper halves (17, 18) extend across a width of the conveyor belt (5).

7. The press according to claim 2, wherein the gripper (17, 18) is constructed as a chuck and is provided with a common drive for a closing movement and the correction movement (16).

8. The press according to claim 1, wherein the displacement device (9) is constructed so that it performs the correction movement (16) with a constant correction stroke when required.

9. The press according to claim 1, wherein at least one belt-edge identification sensor (20, 21) is provided that is arranged and constructed to detect an actual horizontal position of a belt edge of the conveyor belt (5) and generates a correction signal for a given deviation of the actual position from a desired position.

10. The press according to claim 9, wherein two of the belt-edge identification sensors (20, 21) are provided that enclose therebetween a desired region for the horizontal position of the belt edge of the conveyor belt (5) and generate a correction signal when the belt edge comes into a measurement region of one of the belt-edge identification sensors (20, 21).

11. The press according to claim 8, wherein a belt-edge identification sensor (20, 21) monitors a desired threshold for a position of a belt edge of the conveyor belt (5) and the tensioning device (6) loads the conveyor belts (5) with an asymmetrically acting tension, so that the belt is displaced horizontally toward the belt-edge identification sensor (20, 21) during operation.

12. The press according to claim 1, wherein the displacement device (9) contacts the lower belt run on the conveyor belt (5).

13. The press according to claim 1, wherein several of the press stages (1, 1′, 1″, 1′″) are arranged one above the other each with conveyor belts (5) circulating around the corresponding lower press plates (3).

14. The press according to claim 13, wherein the displacement device (9) comprises, for each of the press stages, at least one gripper with two gripper halves (17, 18) that can be opened and closed, and include gripper bars or clamping chucks that clamp the conveyor belt (5) between themselves in a closed state, and the lower gripper halves (17) of the gripper of at least the press stages (1′) that are arranged above another one of the press stages (1) are provided with rollers.

15. The press according to claim 14, wherein the lower press plate (3) and the upper press plate (4) form, in the closed state, using surrounding, one-part or multiple-part seals (10, 12, 13), a vacuum chamber (14, 15) for the lamination of essentially plate-shaped work pieces under the effect of pressure and heat.

16. The press according to claim 13, wherein the press plates (3, 4) are constructed as heating plates at least up to the lowermost press plate (3) or the uppermost press plate (4).

17. A method for feeding work pieces into and out of a press stage (1) of a press, comprising:
tensioning a conveyor belt (5) for feeding the work pieces in or out of the press stage,
relaxing the conveyor belt when it is stopped before the closing of the press stage (1), and
performing a band-run correction by a correction movement (16) through displacement of the conveyor belt (5) perpendicular to a running direction thereof when it is in a relaxed state and the conveyor belt (5) is stopped.

18. The method according to claim 17, wherein the correction movement (16) is performed only when needed after reaching or exceeding a specified deviation of an actual position of a belt edge of the conveyor belt (5) from a desired position of this belt.

19. The method according to claim 18, wherein the correction movement (16) is performed with a fixed, set correction stroke.

20. The method according to claim 17, wherein a need for the correction movement (16) is triggered by at least one belt-edge identification sensor (20, 21).

21. The method according to claim 20, wherein the conveyor belt (5) is forced towards a side run by an asymmetric tension during operation, and a belt-edge identification sensor (20, 21) detects when a run threshold is reached for an actual position of the belt edge of the conveyor belt (5) and triggers the correction movement (16) during the next, relaxed belt stoppage.
